(19) United States
(12) Patent Application Publication
(10) Pub. No.: US 2011/0121681 A1
(43) Pub. Date: May 26, 2011

(54) ELECTROCHEMICAL-BASED MECHANICAL OSCILLATOR

(76) Inventor: Ashok V. Joshi, Salk Lake City, UT (US)

(21) Appl. No.: 12/625,348

(22) Filed: Nov. 24, 2009

(51) Int. Cl. H02N 11/00

(52) U.S. Cl. 310/300

(57) ABSTRACT

A mechanical oscillator in accordance with one embodiment of the invention includes first and second electrodes and an electrolyte for conducting ions between the first and second electrodes. A power source, such as a voltage or current source, may be provided to create an alternating current between the first and second electrodes. This alternating current will cause ions to travel back and forth between the first and second electrodes through the electrolyte. The movement of ions will cause the first and second electrodes to physically expand and contract as the electrodes gain and lose mass, thereby creating desired oscillations or vibrations.

### BACKGROUND OF THE INVENTION

1. Field of the Invention

This invention relates to mechanical oscillators and more particularly to electrochemical-based mechanical oscillators.

2. Background

Many everyday devices incorporate mechanical oscillators to produce alternating motion, also known as vibration or oscillation. For example, mechanical oscillators are used to produce oscillation or vibration in devices such as electric toothbrushes, massage chairs, cell phones, and clocks, to name just a few.

Currently, many mechanical oscillators use piezoelectric materials to produce oscillation or vibration. These piezoelectric materials exhibit the piezoelectric effect—the property wherein certain crystals or materials produce an electric potential when a stress is applied thereto. These piezoelectric materials also generally exhibit the reverse piezoelectric effect—the property wherein the crystals or materials produce a stress or strain when an electric potential is applied thereto. These properties make piezoelectric materials good candidates for producing various types of mechanical oscillators. For example, piezoelectric materials may be used to produce computer oscillators, ceramic filters, transducers, ignition elements for gas instruments, buzzers, ultrasonic transceivers, microphones, ultrasonic humidifiers, or the like. Piezoelectric oscillators may also be used in electronic devices such as hard disk drives, mobile computers, IC cards, cellular phones, and the like.

Unfortunately, most piezoelectric devices have one significant shortcoming—most are lead-based. For example, many piezoelectric oscillators are made from lead-based materials such as lead zirconate titanate (“PZT”), lead titanate (PbTiO₂), and lead-zirconate (PbZrO₃). Although these lead-based materials have desirable properties such as high piezoelectric constants and low cost, the lead content is a hazard to both health and the environment. Lead-based piezoelectric materials may also be unsuitable for many applications, including children's toys or devices that contact the skin or are used in conjunction with the human body.

In view of the foregoing, what is needed is a mechanical oscillator that overcomes various shortcomings of convention piezoelectric oscillators. More particularly, mechanical oscillators are needed that do not contain lead while still providing satisfactory oscillation or vibration. Such mechanical oscillators would ideally be inexpensive and consume little power.

### SUMMARY

The invention has been developed in response to the present state of the art and, in particular, in response to the problems and needs in the art that have not yet been fully solved by currently available mechanical oscillators. Accordingly, the invention has been developed to provide a mechanical oscillator that overcomes various shortcomings of the prior art. The features and advantages of the invention will become more fully apparent from the following description and appended claims, or may be learned by practice of the invention as set forth hereinafter.

Consistent with the foregoing, a mechanical oscillator in accordance with one embodiment of the invention includes first and second electrodes and an electrolyte for conducting ions between the first and second electrodes. A power source, such as a voltage or current source, may be provided to create an alternating current between the first and second electrodes. This alternating current will cause ions to travel back and forth between the first and second electrodes through the electrolyte. The movement of ions will cause the first and second electrodes to physically expand and contract as the electrodes gain and lose mass, thereby creating the desired oscillation or vibration. A corresponding method is also disclosed.

In other aspect of the invention, a mechanical oscillator in accordance with the invention includes first and second electrodes and an electrolyte for conducting ions between the first and second electrodes. A chamber may be associated with at least one of the first and second electrodes. A power source may be provided to create an alternating current between the first and second electrodes through the electrolyte. This alternating current will cause ions to travel back and forth between the first and second electrodes, thereby generating and consuming a fluid (i.e., a gas or a liquid) within the chamber. This will cause the chamber to expand and contract, thereby providing the desired oscillation or vibration. A corresponding method is also disclosed.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings in which:

FIG. 1A is a cross-sectional view of one embodiment of an electrochemical-based mechanical oscillator in accordance with the invention;

FIGS. 1B and 1C show the operation of the mechanical oscillator of FIG. 1A;

FIG. 2A is a cross-sectional view of another embodiment of an electrochemical-based mechanical oscillator in accordance with the invention;

FIGS. 2B and 2C show the operation of the mechanical oscillator of FIG. 2A;

FIG. 3A is a cross-sectional view of yet another embodiment of an electrochemical-based mechanical oscillator in accordance with the invention;

FIGS. 3B and 3C show the operation of the mechanical oscillator of FIG. 3A;

FIG. 4 is a cross-sectional view of one embodiment of a physical implementation of an electrochemical-based mechanical oscillator in accordance with the invention;

FIG. 5 is a cross-sectional view of another embodiment of a physical implementation of an electrochemical-based mechanical oscillator in accordance with the invention;

FIG. 6A is a cross-sectional view of yet another embodiment of a physical implementation of an electrochemical-based mechanical oscillator in accordance with the invention; and

FIG. 6B is a cross-sectional view of the apparatus of FIG. 6A after the sides of the apparatus have been crimped.

### DETAILED DESCRIPTION OF THE INVENTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

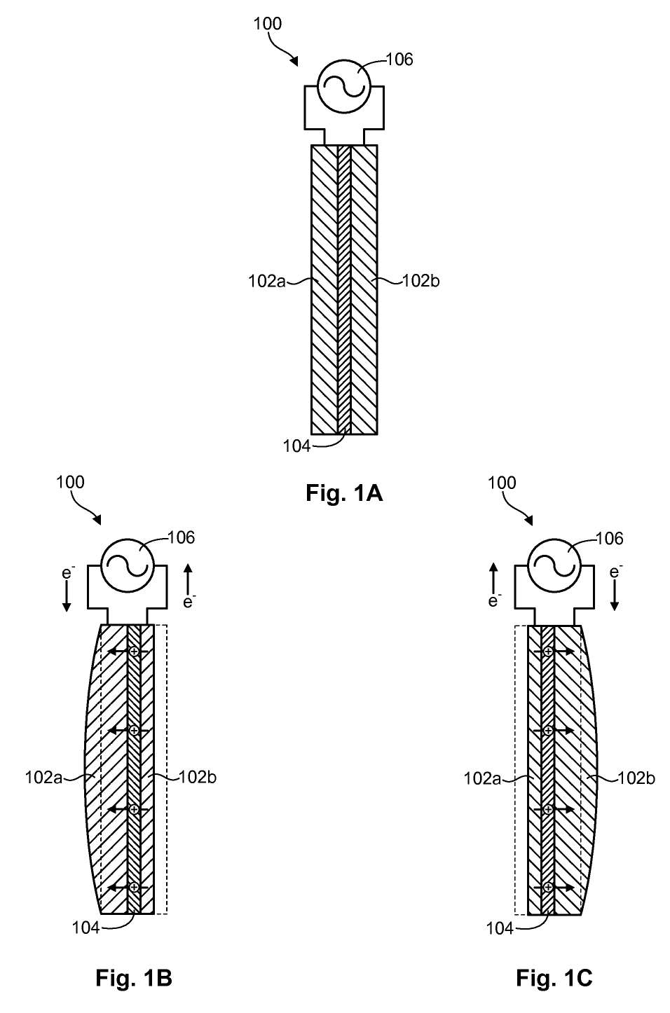

Referring to FIG. 1A, one embodiment of an electrochemical-based mechanical oscillator 100 in accordance with the invention is illustrated. In this embodiment, the mechanical oscillator 100 includes first and second electrodes 102a, 102b and an electrolyte layer 104 to conduct ions between the first and second electrodes 102a, 102b. An AC power source 106 may be provided to create an alternating current between the first and second electrodes 102a, 102b. This alternating current will cause ions to travel back and forth between the first and second electrodes 102a, 102b, thereby causing the electrodes 102a, 102b to expand and contract as each loses or gains mass. This will create a desired oscillation or vibration.

For example, referring to FIG. 1B, when current flows in a first direction, atoms or molecules in the second electrode 102b may lose electrons (e⁻). This may create ions, in this example positive ions, or cations. These ions may travel through the electrolyte layer 104 to the first electrode 102a. At the first electrode 102a, the ions may gain electrons and react to form atoms or molecules. As ions travel from the second electrode 102b to the first electrode 102a, the second electrode 102b may lose mass and the first electrode 102a may gain mass. This will cause the first electrode 102a to expand and the second electrode 102b to contract, as shown in FIG. 1B. The dotted lines in FIG. 1B show the original contour of the electrodes 102a, 102b before their expansion and contraction.

Similarly, referring to FIG. 1C, when current flows in the opposite direction, atoms or molecules in the first electrode 102a may lose electrons (e⁻) and create positive ions. These positive ions may travel through the electrolyte layer 104 to the second electrode 102b. At the second electrode 102b, the ions may gain electrons and react to form atoms or molecules. As ions travel from the first electrode 102a to the second electrode 102b, the first electrode 102a will lose mass and the second electrode 102b will gain mass. This will cause the second electrode 102b to expand and the first electrode 102a to contract. The dotted lines in FIG. 1C show the original contour of the electrodes 102a, 102b before their expansion and contraction.

The electrodes 102a, 102b and electrolyte 104 may be fabricated from any material or materials that will provide the above-described functionality. Thus, the electrodes 102a, 102b and electrolyte 104 are not limited to any specific material or materials.

In selected embodiments, each of the electrodes 102a, 102b may contain silver and the electrolyte layer 104 may contain a silver-ion conductor, such as rubidium silver iodide (RbAg₄I₅). Rubidium silver iodide in particular is extremely conductive to silver ions and is considered a super ion conductor. As an alternating current is applied to the first and second electrodes 102a, 102b, the silver in the electrodes 102a, 102b will be ionized to form silver ions (Ag+). These silver ions will flow back and forth through the electrolyte layer 104 to expand and contract the first and second electrodes 102a, 102b. This will cause the mechanical oscillator 100 to oscillate or vibrate. Stated otherwise, as the silver ions flow back and forth through the electrolyte layer 104, the electrodes 102a, 102b will lose and gain mass, causing the mechanical oscillator 100 to vibrate. The frequency of oscillation or vibration may be modified by simply adjusting the frequency of the alternating current.

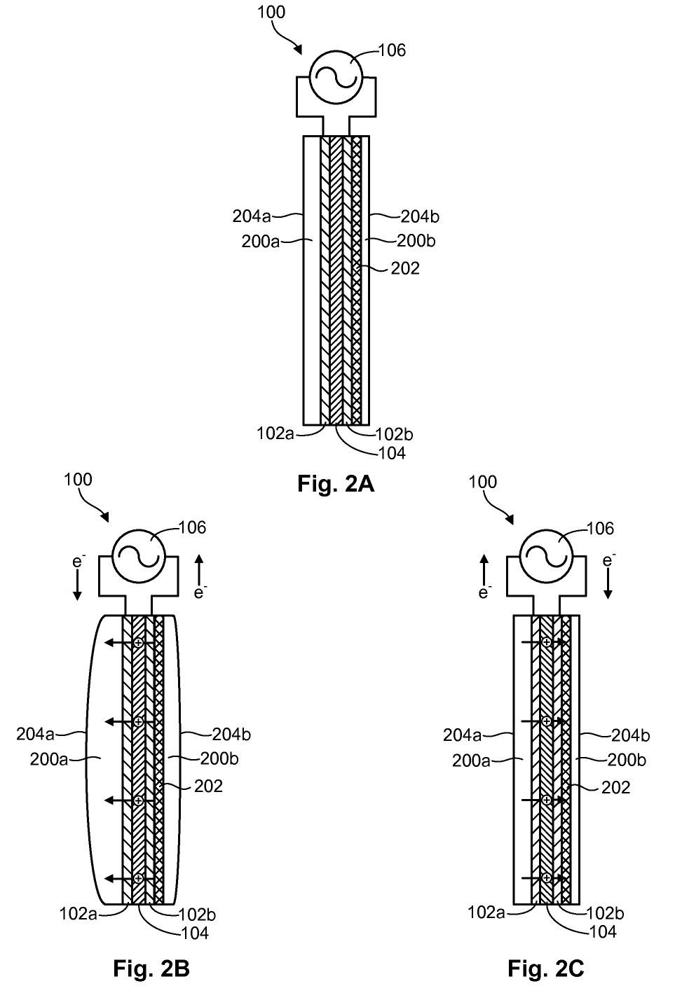

Referring to FIG. 2A, another embodiment of an electrochemical-based mechanical oscillator 100 is illustrated. In this embodiment, the mechanical oscillator 100 includes first and second electrodes 102a, 102b and an electrolyte layer 104 to conduct ions between the first and second electrodes 102a, 102b. A chamber 200a, 200b may be provided proximate one or more of the first and second electrodes 102a, 102b. In selected embodiments, the walls 204a, 204b of the chambers 200a, 200b may be constructed from a resilient material, such as spring steel. This will allow the chambers 200a, 200b to expand and contract without permanently deforming.

Like the previous example, an AC power source 106 may be provided to create an alternating current between the first and second electrodes 102a, 102b. This alternating current will cause ions to travel back and forth between the first and second electrodes 102a, 102b. The flow of ions will cause a fluid to be alternately generated and consumed in one or more of the chambers 200a, 200b, thereby causing the chambers 200a, 200b to expand and contract. This will create a desired oscillation or vibration.

For example, referring to FIG. 2B, when current flows in a first direction, atoms or molecules proximate the second electrode 102b may lose electrons (e−) to create ions, in this example positive ions. These ions may travel through the electrolyte layer 104 to the first electrode 102a. At the first electrode 102a, the ions may gain electrons and react to form a fluid, such as a gas. This fluid will cause the first chamber 200a to expand. In selected embodiments, the atoms or molecules that lose electrons at the second electrode 102b will also generate a fluid, such as a gas. This will cause the second chamber 200b to also expand. The dotted lines in FIG. 2B show the contour of the chambers 200a, 200b prior to their expansion.

Similarly, referring to FIG. 2C, when current flows in the opposite direction, the fluid in the first chamber 200a may lose electrons (e−) to create ions. These ions may travel back through the electrolyte layer 104 to the second electrode 102b. At the second electrode 102b, the ions may gain electrons and react to form atoms or molecules. As ions are conducted through the electrolyte layer 104, the fluid in the first chamber 200a will be consumed, causing the chamber 200a to contract. Similarly, the reaction occurring at the second electrode 102b may cause the fluid (if any) in the second chamber 200b to be consumed. This will cause the second chamber 200b to contract. FIG. 2C shows the mechanical oscillator 100 once it has returned to its original shape.

The mechanical oscillator 100 described in FIGS. 2A through 2C may be fabricated from any material or materials that will provide the above-described functionality. Thus, the electrodes 102a, 102b and electrolyte 104 are not limited to any specific material or materials.

In selected embodiments, each of the electrodes 102a, 102b may contain a catalyst, such as platinum. The electrodes 102a, 102b may also be porous to allow fluids to pass therethrough. The electrolyte layer 104 may include a hydrogen-ion conductor, such as a sulfonated-tetrafluoroethylene-based fluoropolymer-copolymer, such as Nafion®. An absorbent layer 202 containing water may be placed adjacent to the second electrode 102b.

When electrical current flows from the first electrode 102a to the second electrode 102b, hydrogen ions may be separated from the water in the absorbent layer 202 in the presence of the catalyst. These hydrogen ions may be transported through the electrolyte layer 104 to the first electrode 102a. At the first electrode 102a, the hydrogen ions may combine with electrons to form hydrogen gas. This will cause the first chamber 200a to expand as hydrogen gas is generated therein. Similarly, as hydrogen is separated from the water at the second electrode 102b, oxygen gas will be generated. This oxygen will cause the second chamber 200b to expand.

Similarly, when electrical current flows in the opposite direction—from the first electrode 102a to the second electrode 102b—hydrogen ions will be transported through the electrolyte layer 104 to the second electrode 102b. These hydrogen ions will react with the oxygen to form water, which may be absorbed by the absorbent layer 202. This will cause the first and second chambers 200a, 200b to contract as the hydrogen and oxygen gas contained therein is consumed. Thus, using this embodiment, water is repeatedly split and regenerated to provide an oscillating or vibrating motion.

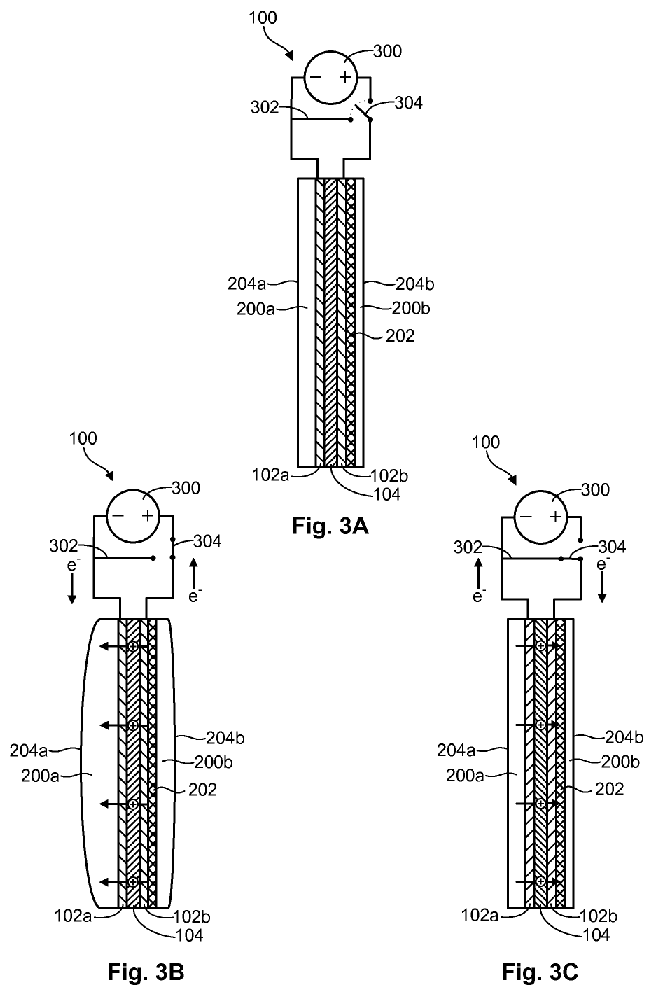

Referring to FIG. 3A, yet another embodiment of an electrochemical-based mechanical oscillator 100 is illustrated. This embodiment is similar to that illustrated in FIG. 2A except that the AC power source 106 is replaced by a DC power source 300 and a shunt 302. A switch 304 may be used to toggle between the DC power source 300 and the shunt 302. The direct current provided by the DC power source 300 may cause ions to travel from the second electrode 102b to the first electrode 102a. This may create a voltage across the first and second electrodes 102a, 102b. The shunt 302 may allow the voltage to discharge through the electrolyte 104. In this way, the DC power source 300 and the shunt 302 together may generate an alternating current in the mechanical oscillator 100. The frequency of the alternating current may be modified by simply adjusting the frequency that the switch 304 toggles between the DC power source 300 and the shunt 302. Like the previous examples, this will provide a desired oscillation or vibration.

For example, referring to FIG. 3B, assume that the absorbent layer 202 contains water and the electrolyte layer 104 is a hydrogen-ion conductor such as Nafion®. When the DC power source 300 is connected to the electrodes 102a, 102b, electrons will flow from the second electrode 102b to the first electrode 102a. This will cause hydrogen ions to be separated from the water in the absorbent layer 202. These hydrogen ions will flow through the electrolyte layer 104 to the first electrode 102a where they may combine with electrons to form hydrogen gas. This will cause the first chamber 200a to expand with hydrogen gas. Similarly, oxygen will be generated in the second chamber 200b, causing the second chamber 200b to expand.

Referring to FIG. 3C, once the shunt 302 is connected (thereby shorting the electrodes 102a, 102b), electrons will flow in the opposite direction without the aid of an external power source. This is because the presence of hydrogen and oxygen gas on opposite sides of the electrolyte layer 104 will generate a voltage across the electrodes 102a, 102b. This will cause the hydrogen gas to ionize. The resulting hydrogen ions will then travel through the electrolyte layer 104 to the second electrode 102b where they will react with oxygen gas to form water. This water may be absorbed by the absorbent layer 202. This will cause the first and second chambers 200a, 200b to contract as the hydrogen and oxygen gas contained therein is consumed.

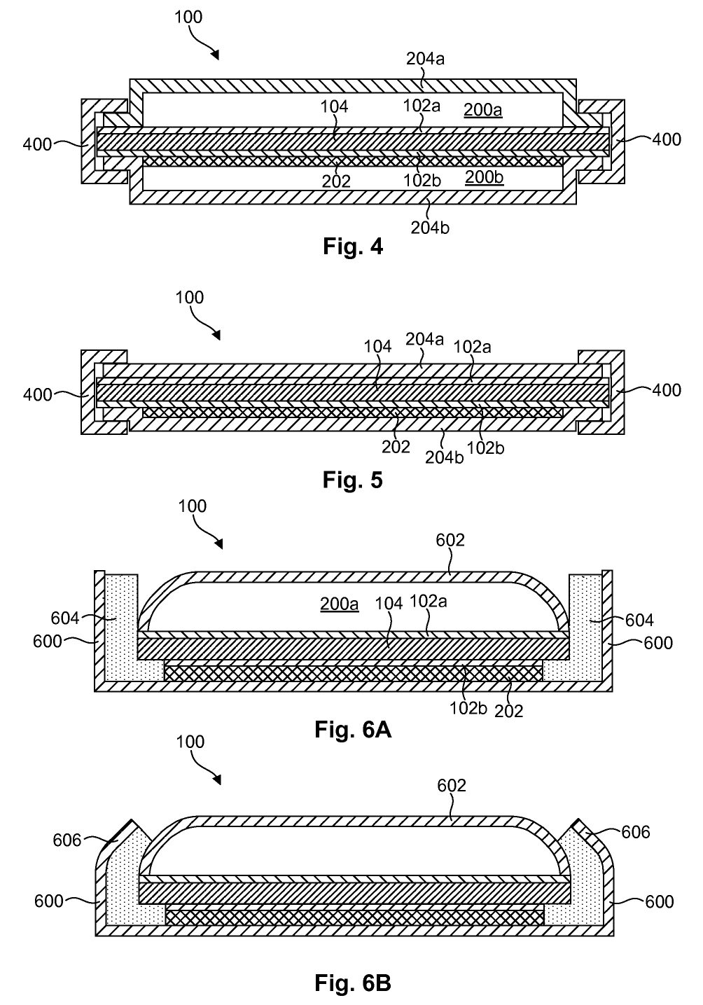

Referring to FIG. 4, one embodiment of an apparatus for physically implementing the mechanical oscillator 100 is illustrated. As shown, the mechanical oscillator 100 includes first and second electrodes 102a, 102b and an electrolyte layer 104 to conduct ions between the first and second electrodes 102a, 102b. Chambers 200a, 200b may be provided proximate the first and second electrodes 102a, 102b, respectively. In selected embodiments, the external walls 204a, 204b of the chambers 200a, 200b may be constructed from a resilient material, such as spring steel, to allow the chambers 200a, 200b to expand and contract without permanently deforming.

In selected embodiments, the electrolyte layer 104 is a substantially solid, rigid layer 104. Similarly, in selected embodiments, the electrodes 102a, 102b are screen printed, adhered, or otherwise placed in contact with each side of the electrolyte layer 104. An absorbent layer 202, if needed, may be placed adjacent to one of the electrodes 102a, 102b. In selected embodiments, a clamping device 400, such as a clip, band, crimp, or the like, may be used to clamp the walls 204a, 204b to the electrodes 102a, 102b or the electrolyte layer 104. In selected embodiments, adhesives, grommets, gaskets, or other sealing elements may be used to create an effective seal between the walls 204a, 204b and the electrodes 102a, 102b or the electrolyte layer 104. This will ensure that the chambers 200a, 200b are fluid-tight to prevent leakage.

In selected embodiments, the walls 204a, 204b are fabricated from an electrically conductive material, thereby allowing an electrical potential to be applied thereto. This electrical potential may be transferred to the electrodes 102a, 102b via direct electrical contact. In such embodiments, the clamping device 400 may be electrically insulating to ensure that the electrodes 102a, 102 are not shorted together.

Referring to FIG. 5, another embodiment of an apparatus for physically implementing the mechanical oscillator 100 is illustrated. This embodiment is similar to that illustrated in FIG. 4 except that the chamber 200a, 200b are not present, at least initially. This embodiment may be used to implement the mechanical oscillator 100 illustrated in FIG. 1A which uses solid materials to create an oscillation or vibration (i.e., does not generate a fluid at either electrode 102a, 102b). However, this embodiment may also be used to implement the mechanical oscillators 100 illustrated in FIGS. 2A and 3A which generate a fluid at one or more of the electrodes 102a, 102b. For example, as fluid is generated at one or more of the first and second electrodes 102a, 102b, the resilient walls 204a, 204b may flex outward to create the chambers 200a, 200b. Conversely, as the fluid is consumed within the chambers 200a, 200b, the walls 204a, 204b may return to their original position adjacent to the electrodes 102a, 102b (or adjacent to the absorbent layer 202, if any). This embodiment 100 provides a more compact design than the embodiment 100 illustrated in FIG. 4.

Referring to FIGS. 6A and 6B, in selected embodiments, the mechanical oscillator 100 may be implemented using a structure similar to many modern-day button cells. Like the previous embodiments, the mechanical oscillator 100 includes first and second electrodes 102a, 102b and an electrolyte layer 104 to conduct ions between the first and second electrodes 102a, 102b. An absorbent layer 202, if required, may be placed adjacent to one of the electrodes 102b.

Each of the mechanical oscillator's components may be enclosed within an outer housing 600 and cap 602. In certain embodiments, the outer housing 600 and/or cap 602 are fabricated from a resilient material, such as spring steel, to allow the housing 600 and/or cap 602 to expand and contract without deforming permanently. In certain embodiments, an electrically insulating material, such as an elastomeric grommet 604, may be inserted between the outer housing 600 and the cap 602. This elastomeric grommet 604 may keep the outer housing 600 and cap 602 electrically isolated as well as keep the internal components isolated from outside elements. As shown in FIG. 6B, in certain embodiments, an outer wall 606 of the outer housing 600 may be crimped or bent to secure the cap 602 and other internal components.

As shown in FIGS. 6A and 6B, the cap 602 has a convex shape, thereby forming a chamber 200a adjacent to the first electrode 102a. In other embodiments (not shown), the cap 602 could be flat and lie adjacent to the first electrode 102a. In such embodiments, as fluid is generated at the first electrode 102a, the cap 602 could flex outward to form the first chamber 200a. Conversely, when the fluid is consumed, the cap 602 could return to its original position adjacent to the electrode 102a. In a similar manner, a second chamber 200b may form as fluid is generated between the second electrode 102b and the outer housing 600 (by causing the outer housing 600 to flex outward).

The present invention may be embodied in other specific forms without departing from its basic principles or essential characteristics. The described embodiments are to be considered in all respects as illustrative and not restrictive. The scope of the invention is, therefore, indicated by the appended claims rather than by the foregoing description. All changes which come within the meaning and range of equivalency of the claims are to be embraced within their scope.

1. A mechanical oscillator comprising:
first and second electrodes;
an electrolyte for conducting ions between the first and second electrodes; and
a power source to create an alternating current between the first and second electrodes, thereby causing ions to travel back and forth between the first and second electrodes, thereby causing the first and second electrodes to physically expand and contract.

2. The mechanical oscillator of claim 1, wherein the electrolyte is a solid electrolyte.

3. The mechanical oscillator of claim 2, wherein the solid electrolyte is substantially rigid.

4. The mechanical oscillator of claim 1, wherein the first electrode expands while the second electrode contracts, and vice versa.

5. The mechanical oscillator of claim 1, wherein the electrolyte comprises a silver-iodide-based material.

6. The mechanical oscillator of claim 5, wherein the electrolyte comprises rubidium silver iodide.

7. The mechanical oscillator of claim 1, wherein the first and second electrodes comprise silver and the ions traveling between the first and second electrodes are silver ions.

8. A method for creating a mechanical oscillation, the method comprising:
providing first and second electrodes;
providing an electrolyte to conduct ions between the first and second electrodes; and
creating an alternating current between the first and second electrodes, thereby causing ions to travel back and forth between the first and second electrodes, thereby causing the first and second electrodes to physically expand and contract.

9. The method of claim 8, wherein providing an electrolyte comprises providing a solid electrolyte.

10. The method of claim 8, further comprising modifying the frequency of the alternating current to modify the frequency of the mechanical oscillation.

11. The method of claim 8, wherein providing an electrolyte comprises providing an electrolyte containing a silver-iodide-based material.

12. The method of claim 11, wherein providing an electrolyte comprises providing an electrolyte containing rubidium silver iodide.

13. The method of claim 8, wherein causing ions to travel back and forth between the first and second electrodes comprises causing silver ions to travel back and forth between the first and second electrodes.

14. A mechanical oscillator comprising:
first and second electrodes;
an electrolyte for conducting ions between the first and second electrodes;
a chamber associated with the second electrode; and
a power source to create an alternating current between the first and second electrodes, the alternating current causing the chamber to physically expand and contract by alternately generating and consuming a fluid within the chamber.

15. The mechanical oscillator of claim 14, wherein the fluid is a gas.

16. The mechanical oscillator of claim 14, wherein the electrolyte is a solid electrolyte.

17. The mechanical oscillator of claim 14, wherein the alternating current further causes a compound to be decomposed and recomposed at the first electrode.

18. The mechanical oscillator of claim 17, wherein the compound is a solid compound.

19. The mechanical oscillator of claim 18, wherein the compound is a liquid compound.

20. A method for creating a mechanical oscillation, the method comprising:
providing first and second electrodes;
providing an electrolyte for conducting ions between the first and second electrodes;
providing a chamber associated with the second electrode; and
creating an alternating current between the first and second electrodes, the alternating current causing the chamber to physically expand and contract by alternately generating and consuming a fluid within the chamber.

21. The method of claim 20, wherein generating and consuming a fluid comprises generating and consuming a gas.

22. The method of claim 20, wherein providing an electrolyte comprises providing a solid electrolyte.

23. The method of claim 20, wherein the alternating current further causes a compound to be decomposed and recomposed at the first electrode to generate and create the fluid at the second electrode.

24. The method of claim 23, wherein the compound is a solid compound.

25. The method of claim 23, wherein the compound is a liquid compound.
